(19) United States
(12) Patent Application Publication
(10) Pub. No.: US 2009/0041987 A1
(43) Pub. Date: Feb. 12, 2009

(54) PANEL COMPRISING A DECORATIVE LAYER

(76) Inventor: Leonhard Schitter, Hallwang (AT)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/816,116

(22) PCT Filed: Oct. 31, 2005
(86) PCT No.: PCT/EP2005/055647

§ 371 Date: Sep. 24, 2008

(30) Foreign Application Priority Data
Feb. 11, 2005 (DE) 10 2005 006 532.5

(51) Int. Cl. B32B 3/10

(52) U.S. Cl. 428/172; 428/195.1

(57) ABSTRACT

The invention relates to a panel having a layered structure, the panel especially comprising a stress-bearing board provided with a decorative layer attached thereto. Further, the invention relates to a method for producing one such panel.

The invention relates to a panel having a layered structure, the panel especially comprising a stress-bearing board provided with a decorative layer attached thereto. Further, the invention relates to a method for producing such a panel.

In the area of flooring, panels of the kind specified at the beginning are called laminate flooring or parquet. As a rule, a laminate flooring has a carrier board generally produced from HDF, MDF or chipboard material. A so-called decorative paper is located above the carrier board, as well as, as a rule, another layer that provides for sufficient abrasion resistance on the surface. However, the decorative paper can also be made abrasion-resistant already. A so-called counteracting paper is located underneath the carrier board.

A laminate flooring can be laid in a floating manner or glued to the subsurface.

In particular the papers are impregnated with aminoplastics, in particular with urea resins and/or melamine resins, If the papers are pressed in a press with the carrier board while exposed to temperature and pressure, the resins soften and harden.

The decorative paper provides for the desired visual impression of the flooring formed from the panels. The counteracting paper is to ensure that the carrier board or the panel does not warp during the pressing of the layers or papers.

In particular, parquet panels differ from a laminate in their surface. The desired visual appearance is caused by wood and, thus, not by printed paper. A parquet flooring consists of solid wood but may, however, also have a carrier board of HDF, MDF or chipboard material. In that case, however, a wood veneer layer is applied to the top side. A wood layer or paper is applied to the back in this case, as a counteracting device.

If panels are laid on a flooring subsurface, then a comparatively large noise level occurs when the flooring is stepped on. In order to avoid such a noise level, it is already provided in the prior art to employ a so-called footfall-sound insulation. This is a layer applied underneath a panel with sound-insulating and/or sound-absorbing properties. In addition or alternatively, the layer may cause a shift in frequency and loudness of the sound generated, which are then such as to be subjectively perceived as less irritating.

The layer that brings about the footfall-sound insulation will herein be generally referred to as “sound-improving layer”.

Sound-improving layers are, in particular, constituted as follows:

As a rule, the sound-improving layer is elastically deformable in comparison the above defined Panel. Such a layer consists, for example, of polyurethane recycling material, rubber, cork, foams, thermoplastic materials, fiber mats or LDF (low density material). As a rule, the density is about 200 to 1000 kg/m³.

Alternatively, a so-called heavy foil can be employed as a sound-improving layer. This exhibits a weight of more than 1000 g/m².

A heavy foil—glued to the laminate or pressed with it—provides for a good contact with the flooring subsurface, which improves the way it lies on the plane underneath, thus improving the sound perception when the floor is stepped on. Typically, a heavy foil consists of polyethylene with fillers.

The above-mentioned prior art is described in the printed publication DE 201 17 646 UI. From it, it is also known to press a sound-improving layer together with further layers. The sound-improving layer is applied on the underside.

Thus, panels are, on the one hand, supposed to be attractive as regards their visual appearance, and, on the other hand, panels are supposed to make it possible to provide hard-wearing, inexpensive coverings that are easily laid. If panels are used as floor coverings, the amount of irritating noises is supposed to be small when the panels are stepped on. The sensation when walking on them is supposed to be pleasant.

The object of the invention lies in the further development of a panel of the kind mentioned at the beginning.

Die object of the invention is achieved by a panel having the features of the main claim. Advantageous embodiments result from the dependent claims.

A layer which preferably is available in the form of sheet products or particularly preferably as roll products is provided in the production of a panel according to the invention, as compared to the prior art. The layer can consist of sound-improving material in the above mentioned sense, that is, in particular, of polyurethane recycling material, rubber, cork, foams, thermoplastic materials, fiber mats or LDF.

In addition or alternatively, they may be layers of stone or ceramics that act like heavy foil. It may be fabrics, textiles, carpet tiles or linoleum.

The materials mentioned in the above paragraph, in contrast to the prior art, are preferably applied to the top side, namely in such a way as to be visible in the laid state, On the one hand, a sound insulation is often thus achieved, and on the other hand, new and previously unattained advantages can be achieved at the same time.

If the uppermost layer consists of stone or tiles, then, in the case of a floor covering, a panel is firmly pressed onto the subsurface by the relatively large own weight thus provided. Sound generated when the covering is stepped on is thus guided into the subsurface particularly well, which has an advantageous effect on the noise insulation.

Laying is very simple compared to conventional tiles or stone floorings, because a floating installation is possible, and because tiles or stone need not be glued to the subsurface. This is especially true if panels are provided with such coupling elements that enable an adhesive-free connection of the panels.

Compared to conventional laminate or parquet panels, a surface of ceramics or stone is mechanically resilient and wear-resistant. In addition, no swelling occurs in the area of the joints, as is the case in conventional laminate or parquet flooring.

Compared to conventional stone tiles or ceramic tiles, the upper layer consisting of stone or ceramics is comparatively thin, namely preferably thinner than 5 mm, particularly preferably thinner than 3 mm. Significant advantages with regard to cost are then the result, in particular compared the stone floorings, since it is possible to save on expensive stone material. This is similarly true for high-quality ceramic materials.

A novel visual effect results from the decorative surface consisting of metal, namely preferably of relatively soft metals such as aluminum. Metals can be pressed together with other layers, so that, subsequently, only processing by sawing and milling may be required. Furthermore, a metal is mechanically resilient and can be cleaned easily. In the case of metal, the metal layer is preferably very thin, for reasons of cost. Therefore, the thickness is advantageously less than 1 mm, particularly preferably less than 0.5 mm.

Walking on a carpet is comparatively pleasant and quiet. If the panels have a surface of textiles, felt or carpet tiles, then the sensation when walking on them is comparatively pleasant. In addition, such panels have a comparatively low noise level, Laying panels is comparatively easy compared to laying conventional carpet. This applies in particular, when panels have connection elements that enable an adhesive-free connection of two panels. In contrast to carpeting, dirty areas can easily be replaced if panels are connected with each other in an adhesive-free manner.

Novel visual effects are possible with the other sound-improving materials mentioned.

In order to improve sound insulation further, a panel according to the invention has a sound-improving layer on the underside and/or inside of each panel.

Especially in order to achieve an appearance of stone or tile flooring, the laid panels additionally have a visible border in the area of the joint with a preferred width of at least 1 mm. The border can consist of elastic material such as rubber or silicone in order to make an additional contribution so that no dirt or moisture enters the joints.

The roll or sheet products are advantageously pressed together with the other components in a press, in particular at temperatures of at least 100° C. Preferably, higher temperatures are provided during pressing, in particular above 120° C., Typically, the temperatures are above 200° C. They are preferably between 230° C. and 250° C. in order to obtain short pressing times, Short pressing times make a fast production of panels possible so that the method is cost-effective.

The sheet or roll products must be appropriately thermally stable. Thus, if pressing is done at 200° C., then the materials used, of which the layers consist, are to be selected such that they withstand the selected temperature.

Papers or layers adjoining the sound-improving layers are preferably impregnated with aminoplastics in the production of a laminate panel. During pressing, the aminoplastic material used causes the sound-improving layer to be attached to the panel.

The connection thus established between the sound-improving layer and the panel is particularly stable.

The method of production is cost-effective. The provision of additional adhesives can also be dispensed with. This results in advantages with regard to costs. In addition, the method is environmentally friendly since no adhesives must be used that must be disposed of additionally. Solvents that are possibly contained in adhesives are avoided.

According to the method, after a large board with layers attached thereto has been manufactured, panels having the dimension of, for example 1.40 m×0.20 m are sawed out and the locking elements such as grooves and tongues are milled in. This results in a flush boundary at the edge between the individual layers. However, the panels may also be larger or smaller. Further layers can be connected with the sawed-out panels after sawing.

Because the attachment between the layers is very strong, milling can be done without any problems.

In one embodiment of the invention, polyurethane recycling material is used, and the sound-improving layer formed therefrom. The material is inexpensive. It has very good sound-improving properties. It is recovered from the recycling industry, so that it is environmentally compatible. If this material is used on the surface, this results both in pleasant walking properties as well as novel decorative effects at the same time.

A sound-improving layer should be at least 0.5 mm thick in order to attain good sound-improving properties that are acceptable to the consumer. In practice, the layer of polyurethane recycling material can be up to 5 mm thick.

If the sound-improving layer is very thick, noticeable disadvantages regarding heat conductivity are the result. Good heat conductivity is of interest when laying or using a floor heating system. A laminate flooring that is too thick is also not desirable because the structural height becomes too great after laying. This is disadvantageous for the consumer, since he must then adapt doors, for example, accordingly, which is common, for example, in renovation.

Melamine resin and/or urea resin and/or mixtures thereof are preferably used as aminoplastics. These are the resins that are typically used for the decorative paper and for the counteracting paper. If these resins are used, no additional material component need be provided for manufacturing the product.

The pressing pressure is typically between 5 and 70 kPa. Generally, a sound-improving layer consisting of flexible material is compressed by the method. The compression remains at least partly in the finished product. If polyurethane (PUR) is used, the layer typically compresses from, for example, 1.2 mm to 0.5 mm. Due to the conservation of mass, the sound-improving properties change insignificantly, if at all.

Polyurethane recycling material having a density between 110 kg per cubic meter and 750 kg per cubic meter can be used as starting material for a sound-improving layer.

In another embodiment of the invention, a material from which a heavy foil is produced is used as a sound-improving layer, alternatively or in addition to polyurethane recycling material. Preferably, polyethylene with fillers is provided.

Experiments have shown that the materials mentioned, polyurethane recycling material, as well as polyethylene with fillers, are particularly good for obtaining sound-improving properties. Furthermore, these materials could be processed and attached to a laminate panel without any problems.

Roll products are preferably used in the production in order to be able to press continuously in a double-belt press. Otherwise, a short-cycle press would have to be used, which would render production more expensive. This applies mainly to large-scale production.

The selected materials polyurethane recycling material and polyethylene with fillers are thermally stable so that they can be pressed while being exposed to temperature. They are particularly suitable also for this reason.

Typically, the thickness of a panel is 5 to 20 mm. However, it can also, in particular, be thinner.

The decorative layer is preferably thinner than the panel, namely in particular thinner than the carrier board. Preferably, the carrier board is at least 5 mm thick in order to provide the desired stabilizing properties of a panel.

In one embodiment of the invention, a pattern is printed, painted and/or embossed onto the sound-improving layer, In the latter case, the sound-improving layer has a three-dimensional structure in order to imitate, for example, the geometry of a roughly polished stone, or the pores of a wood. The print can then represent a wood, stone or an fantasy image. A transparent wear-resistant layer can be applied above the print.

Thus, the sound-improving layer takes on a dual function. On the one hand, it forms the carrier for the décor, and on the other hand, is improves the sound perception.

The sound-improving layer consists, in particular, of a material that exhibits elastic behavior or is thermoplastic, if the sound-improving layer is located at the top side of a panel. In that case, impacts during walking are immediately attenuated and sound waves are transmitted into layers underneath only in a reduced manner.

In one embodiment of the invention, a decorative layer is glued onto the stress-bearing board separately, in particular when pressing with further layers entails problems for reasons relating to the production process. This especially applies to the case of surfaces of stone or ceramics.

The focus for the materials according to the invention always lies also on the particular decorative properties. As a rule, however, it is not only a decorative effect, but furthermore, advantages can be presented with regard to the feeling of warmth and sound absorption, heat conductivity etc. As a rule, plastics are suitable to combine all the aforementioned properties with each other.

In the case of a floor heating system, metals are particularly preferably processed.

If heat insulation is to be obtained, then materials that do not conduct heat well will be selected. They include plastics and cork. In that case, the associated layers are advantageously made thick. Then, the thickness is preferably at least 2 mm, particularly preferably at least 4 mm.

The carrier material may be wood, wood-based materials, but also other materials, such as plastic, paper honeycombs etc.

The invention is explained further below by means of embodiments shown in the drawings.

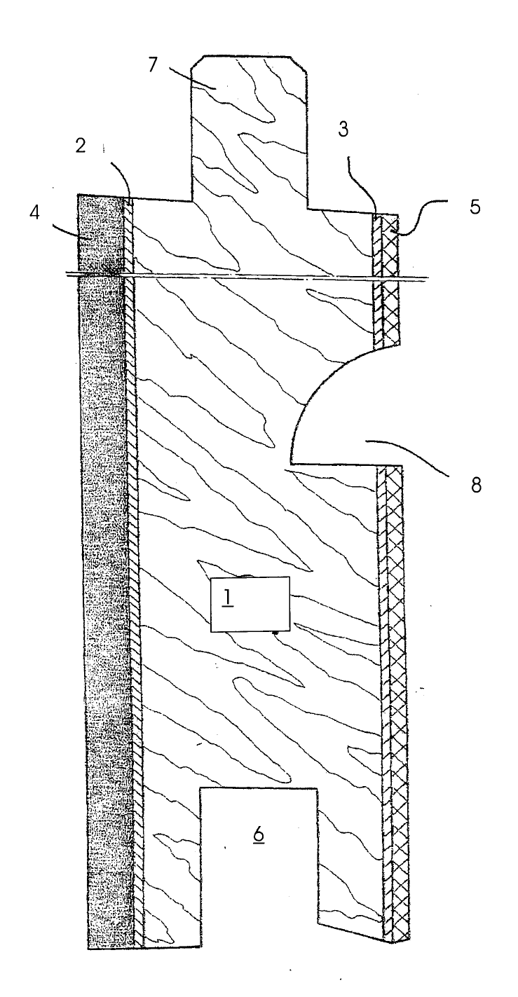

FIG. 1 shows a section of a laminate panel produced from a carrier board 1, an optional paper 2, an optional counteracting paper 3, as well as a decorative layer 4. The carrier board 1 consists of MDF/HDF (however, other materials such as plywood, plastics, paper layers glued and pressed together are also possible). This material is made of wood fibers first provided with glue and then pressed to form a board in a press. First, the paper layer 2 is applied to the carrier board 1. The counteracting paper 3 is located underneath the carrier board 1.

The decorative layer 4 in particular consists of the above-mentioned materials such as stone, ceramics, textiles, carpet tiles, linoleum, aluminum, or also of cork.

The paper layers have first been provided with a mixture of a melamine resin and/or urea resin. The resins are softened while being supplied with heat and pressure. A firm connection between the various layers has been formed by subsequent hardening.

According to the invention, a sound-improving layer 5 was additionally preferably pressed together with the other aforementioned layers during production. In that case, the sound-improving layer consists of polyurethane (PUR). At first the layer thickness was 1.2 mm. By pressing the various layers, the thickness was reduced to 0.5 mm. The sound-improving layer 5 is bonded with the counteracting paper 3 because of the resins used.

After the composite of layers was produced, a groove 6, a tongue 7 were milled laterally into the panel, and (if needed) a groove 8 was milled into the underside of the panel. In addition, further locking elements that are not shown can be milled in, which serve the purpose of connecting by positive fit in a parallel direction relative to the surface of the covering and perpendicular to the common joints.

The method of production results in the transition from the sound-improving layer 5 to the panel being flush. This applies both on the lateral borders of the panel, as well as at the transitions occurring within the groove 8.

Metal clips that interlock two panels 1 in a horizontal direction can be inserted into the groove 8 of a panel and the corresponding groove 8 of another panel. Thus, a groove 8 on the underside is allocated to each groove and each tongue. For reasons of clarity, only one groove 8 was drawn into the figure. Had the panel been drawn in its entirety, then another groove 8 allocated to the tongue 7 could be seen in mirror image.

In particular joints between two panels can be partly filled with a preferably flexible material from above in the laid state, so as to, on the one hand, prevent moisture and dirt from entering and, on the other hand, make additional decorative effects possible in the manner known, for example, from WO 03/087497 A1. We incorporate the content of that printed publication into the content of disclosure of the present application, in particular, where it concerns the provision of borders with a decorative effect of individual panels as well as adhesive-free connections.

In an embodiment not shown, a panel may comprise two boards of wood-based material material. A layer of sound-improving material within the sense mentioned at the beginning is disposed between the two boards or layers of wood-based material. This embodiment serves the purpose of further improving the acoustic properties of a panel.

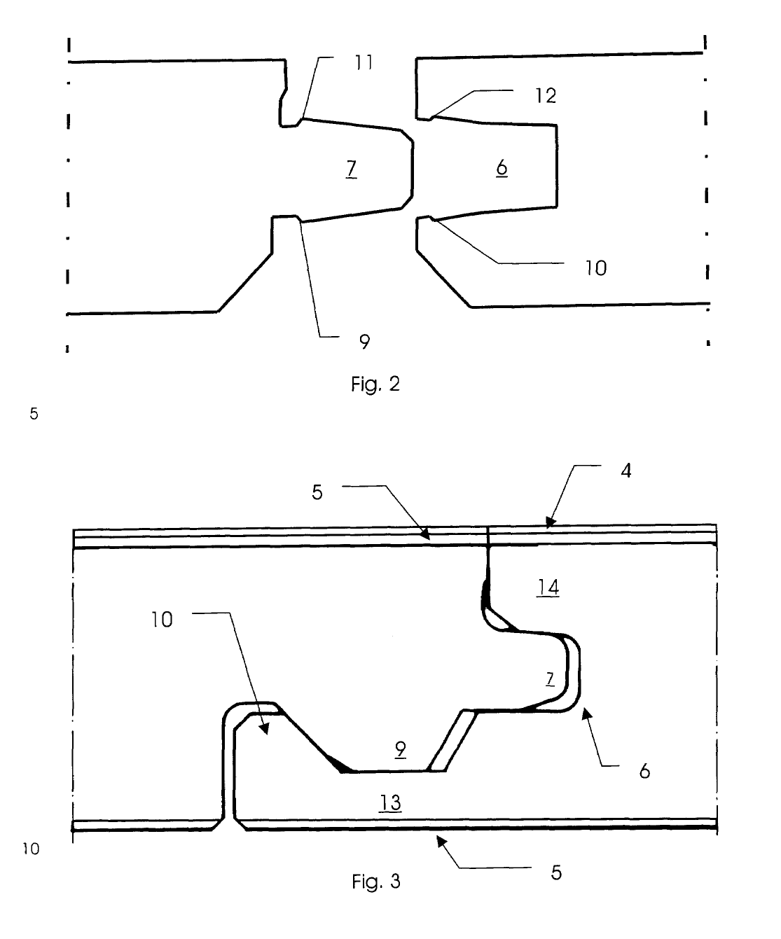

FIG. 2 shows panels which, apart from groove 6 and tongue 7, have further locking elements 9 and 10 that make an adhesive-free connection of two panels possible. In another embodiment, the adhesive-free connection can be reinforced by means of further locking elements 11 and 12 at the respectively opposite side of groove and tongue. Preferably, locking elements 9 and 10 are located underneath the tongue or at the lower groove flank. This ensures that no impressions form on the surface of panels.

In the case of FIG. 2, connecting two panels takes place by shifting in a plane, that is, in a manner the consumer is used to from glued panels. For reasons of simple installation, an embodiment that makes possible a connection by shifting in a plane preferably is to be arranged at least on narrow sides of panels.

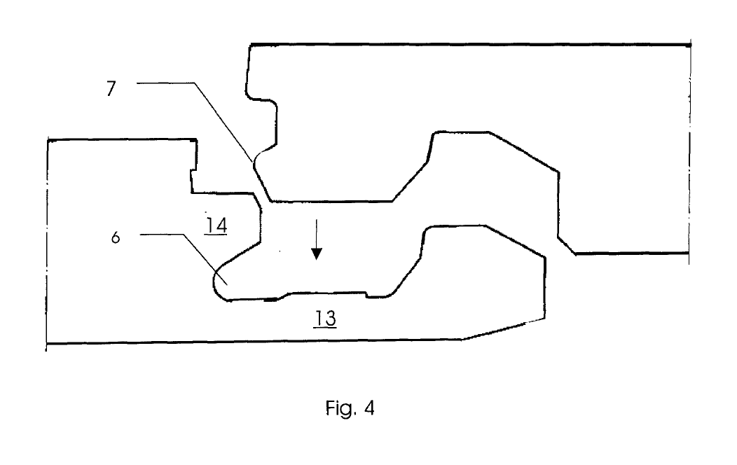

FIG. 3 illustrates an embodiment wherein the stress-bearing board of a panel is provided on both sides with sound-improving layers 5. A decorative layer 4 that can consist of printed paper with a transparent wear-resistant layer on top is disposed above one of the two sound-improving layers. A décor can also have been printed directly onto a sound-improving layer, that is, onto an outer layer 5.

FIG. 3 furthermore shows another possibility of connecting panels with each other in an adhesive-free manner. A lower groove flank 13 protrudes over a top groove flank 14. Thus, there is more room for locking elements 9 and 10 that make an adhesive-free connection possible. As a result, a more stable connection parallel to the flooring surface can be achieved in this manner. Other methods for connecting result depending on the dimensions of the coupling and locking elements. In the embodiment shown in FIG. 3, two panels can be connected by tilting, in particular, when the lower groove flank 13 cannot be elastically displaced downwardly in a sufficient extent. For reasons of simple installation, such a connection is preferably only provided on long sides of a panel.

FIG. 4 also shows an embodiment having a lower protruded groove flank 13. Since in this case the flank 7 protrudes comparatively little, this embodiment makes a connection by lowering along the arrow possible.

1-10. (canceled)

11. A panel for a laminate flooring comprising several layers including a layer of sound-improving material, which layer is provided with a décor visible in the laid state.

12. A panel according to claim 11, wherein the décor is printed, painted and/or embossed on the sound-improving layer.

13. A panel according to claim 12, comprising a stress-bearing board of HDF, MDF or chipboard material, and wherein the sound-improving layer comprises polyurethane recycled material, rubber, foam, thermoplastic material or LDF.

14. A panel according to claim 11, comprising a stress-bearing board of HDF, MDF or chipboard material, and wherein the sound-improving layer comprises polyurethane recycled material, rubber, foam, thermoplastic material or LDF.
